(19) United States
(12) Patent Application Publication
(10) Pub. No.: US 2014/0153937 A1
(43) Pub. Date: Jun. 5, 2014

(54) PRINTING SYSTEM, PRINTING APPARATUS, METHOD OF CONTROLLING THE SAME, AND STORAGE MEDIUM

(71) Applicant: Canon Kabushiki Kaisha, Tokyo (JP)

(72) Inventor: Koichi Unno, Yokohama-shi (JP)

(73) Assignee: Canon Kabushiki Kaisha, Tokyo (JP)

(21) Appl. No.: 14/075,329

(22) Filed: Nov. 8, 2013

(30) Foreign Application Priority Data
Dec. 3, 2012 (JP) 2012-264740

(51) Int. Cl. G03G 15/00

(52) U.S. Cl. CPC G03G 15/70
USPC 399/21

(57) ABSTRACT

A printing system, a printing apparatus, a method of controlling the same and a storage medium. The printing apparatus determines whether a sheet jam occurs while print processing is performed, interrupts the print processing in a case where it is determined that the sheet jam occurs, and conveys a sheet remaining on a sheet conveyance path to a sheet holding unit. The apparatus detects whether or not there is a sheet in the sheet holding unit, and makes a notification to a user instructing removal, from the sheet holding unit, of a sheet in a case where it is detected that there is a sheet in the sheet holding unit.

### BACKGROUND OF THE INVENTION

1. Field of the Invention

The present invention relates to a printing system, a printing apparatus, a method of controlling the same and storage medium.

2. Description of the Related Art

In recent years, digital copying machines have functions to interpret PDL language (page description language) transmitted from a computer connected to a network, generate image data, and perform printing in accordance with the image data, unlike digital copying machines that simple perform copying. Amongst these kinds of digital copying machines, there are some that are connected to feed accessories for feeding a large amount of sheets, and to discharge accessories (sheet processing apparatus) having functions such as those for sorting, shifting, stapling, and punch pressing print materials, and that comprise in a POD (print on demand) printing system. In such a configuration, because the distance that a fed sheet is conveyed is longer, when feeding, printing, and discharging is performed one sheet at a time, the number of sheets printed in a unit time is less. Accordingly, in order to increase the number of sheets printed in a unit time, feeding, printing and discharging are performed for multiple sheets continuously.

In cases where a paper jam (sheet jam) occurs on standard digital copying machines, a location of the paper jam is displayed to an operation unit, and a user is guided to manually remove the sheet that caused the paper jam. However, with a copying machine connected to a feed accessory and a discharge accessory (sheet processing apparatus) as previously described, since the distance fed sheets are conveyed is long, multiple sheets are continuously fed, printed and discharged. For this reason, when the paper jam occurs, it is necessary to remove sheets stopped in the paper jam at multiple locations on a conveyance path (sheet conveyance path). Having the user handle a paper jam having multiple locations at distances from each other places a burden on the user.

In Japanese Patent Laid-Open No. 2009-220966, in order to reduce the burden on the user when such a paper jam occurs, by evacuating sheets on the conveyance path other than the sheet at the location at which the paper jam occurred to an evacuation area, a reduction in an amount that the user has to deal with paper jams is achieved.

However, with the above described technique, even in a case where the paper jam occurs when printing a document with important content, the sheets on the conveyance path are moved to the evacuation area and stored there. Thus, the user may forget to remove the important document in the evacuation area, and the document may be seen by another person.

### SUMMARY OF THE INVENTION

An aspect of the present invention is to eliminate the above-mentioned problems with the conventional techniques.

A feature of the present invention is to provide a technique in which not only are sheets conveyed to a sheet holding unit in a case where a sheet jam occurs, which reduces the need for users to have to deal with sheet jams, but also the user is enabled to instruct a continuation of the printing after the fact that a sheet is in the sheet holding unit is made clear.

According to an aspect of the present invention, there is provided a printing apparatus comprising: a determination unit configured to determine whether or not a sheet jam occurs while print processing is performed; a control unit configured to interrupt the print processing in a case where it is determined by the determination unit that the sheet jam occurs, and to convey a sheet remaining on a sheet conveyance path to a sheet holding unit; a detection unit configured to detect whether or not there is a sheet in the sheet holding unit; and a notification unit configured to make a notification to a user instructing removal, from the sheet holding unit, of a sheet in a case where the detection unit detects that there is a sheet in the sheet holding unit.

According to another aspect of the present invention, there is provided a printing system having a printing apparatus, and a sheet processing apparatus for conveying a sheet on which an image is printed by the printing apparatus, the printing system comprising: a first determination unit configured to determine whether a sheet jam occurs; a second determination unit configured to interrupt print processing by the printing apparatus in a case where the first determination unit determines that the sheet jam occurs, and configured to determine whether or not the sheet processing apparatus has a sheet holding unit for holding a sheet remaining on a sheet conveyance path; a detection unit configured to detect whether or not a sheet is in the sheet holding unit in a case where the second determination unit determined that the sheet processing apparatus has the sheet holding unit; and a notification unit configured to make a notification to a user instructing removal, from the sheet holding unit, of a sheet in a case where the detection unit detects that there is the sheet in the sheet holding unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view for showing a configuration of a printing system according to an embodiment.

FIG. 2 is a cross-section view of a scanner and a printer according to the embodiment.

FIG. 3 is a cross-section view of a stacker according to the embodiment.

FIG. 4 is a block diagram for showing a configuration of a controller of the printer according to the embodiment.

FIG. 5 is a top view of an operation unit according to the embodiment.

FIGS. 6A and 6B are flowcharts for describing control processing executed by the printer according to the embodiment.

FIG. 7 is a view for showing an example of a screen displayed to the operation unit showing a paper jam location according to the embodiment.

FIG. 8 is a view for showing an example of a screen instructing removal of a sheet from an evacuation area according to the embodiment.

FIG. 9 is a view for showing an example of a copy processing on waiting screen according to the embodiment.

### DESCRIPTION OF THE EMBODIMENTS

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required with respect to the means to solve the problems according to the present invention.

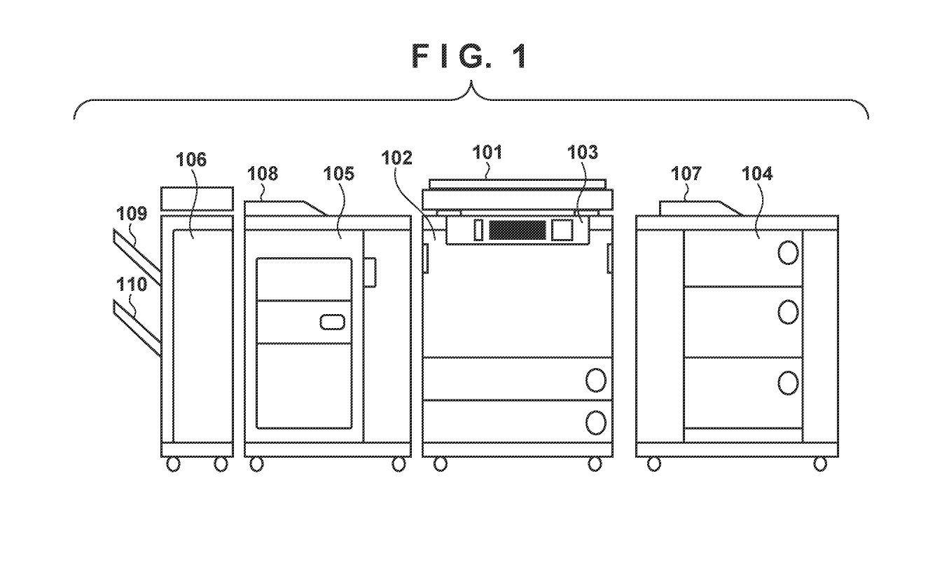

FIG. 1 is a view for showing a configuration of the printing system according to the embodiment.

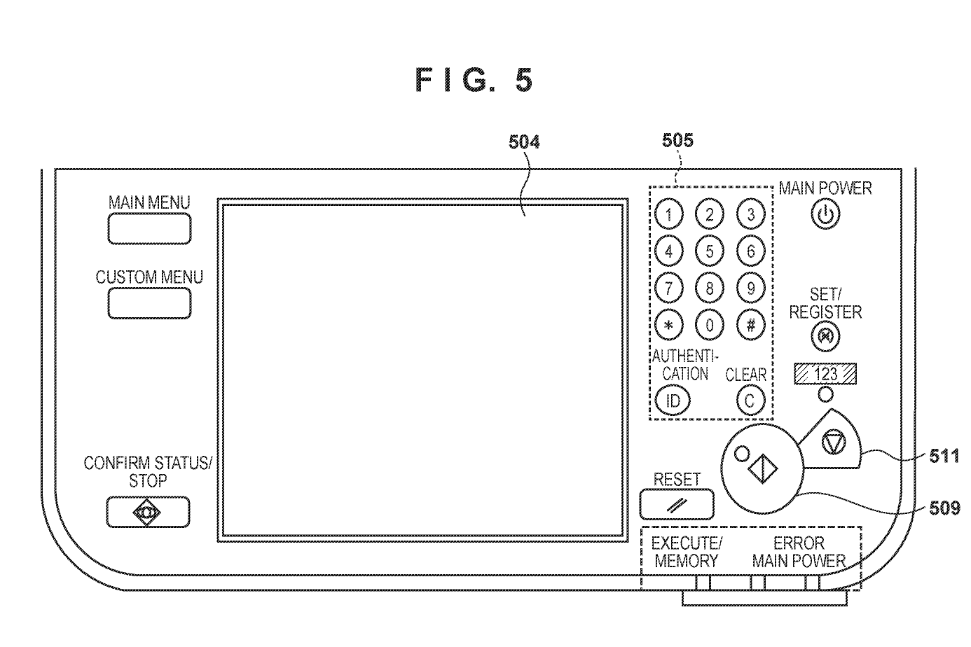

In FIG. 1, a scanner 101 generates image data by scanning an original. A printer 102 performs printing of a sheet based on image data. An operation unit 103 is operated by the user, and is used by the user for inputting various setting values. Also, the operation unit 103, which has a touch panel display panel 504 (FIG. 5), displays messages and instructions to the user, and inputs various information according to operation by the user on the display panel. A feed accessory 104 stocks, and feeds to the printer 102, a large amount of sheets. Numeral 107 denotes an escape tray of the feed accessory 104.

A stacker 105 accumulates printed sheets discharged from the printer 102. Also, the stacker 105 is able to convey printed sheets discharged from the printer 102 to a following finisher 106. The finisher 106 staples, punch presses and sorts printed sheets discharged from the printer 102. Numeral 108 denotes an escape tray of the stacker 105. Also, numerals 109 and 110 denote discharge trays of the finisher 106.

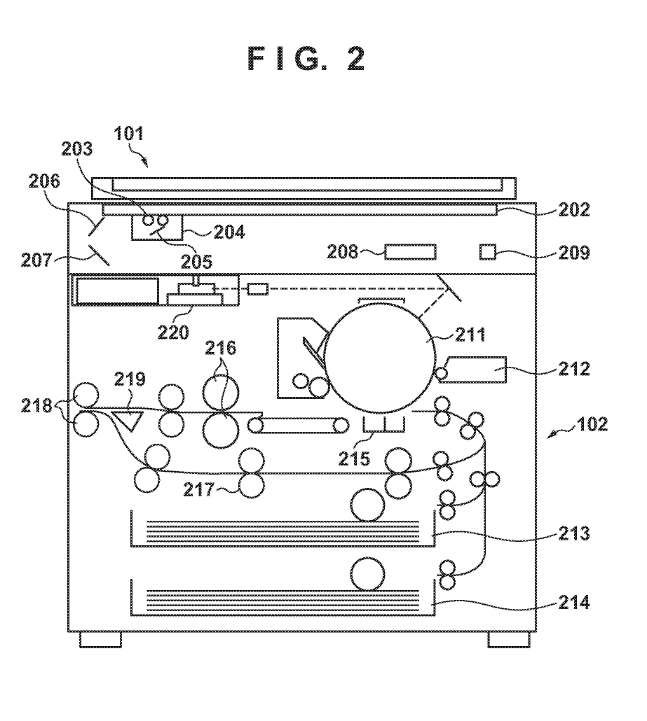

FIG. 2 is a cross-section view of the scanner 101 and the printer 102 according to the embodiment.

An original placed on a contact glass 202 is exposed by a lamp 203 and the entire original is scanned by leftward/rightward movement (from the perspective of FIG. 2) of an optical unit 204. Reflected light from the original is guided by mirrors 205, 206 and 207, and by a lens 208 to a CCD line image sensor (hereinafter referred to as the CCD) 209. The original is read by the CCD 209, and image data corresponding to the image of the original is output from the CCD 209.

The image data, having been transferred to the printer 102, is converted from image data into a laser beam by a laser unit 220, and is formed as an image on a photosensitive drum 211 by the laser beam from the laser unit 220, forming an electrostatic latent image. The electrostatic latent image becomes a visible image due to toner supplied from a developer unit 212, and the visible image is transferred to a sheet fed from feed cassettes 213, 214 by a transfer unit 215. The sheet, to which the image is transferred, is conveyed to a fixing unit 216, and after the image is fixed, the sheet is conveyed to the stacker 105 by rotation of a conveyance roller 218. Also, in cases where both sides of the sheet are printed, the sheet to which the image is transferred is sent to a conveyance path for double-sided printing by a flap 219 and is sent once again, by rotation of a conveyance roller 217, to the transferring position in order that an image be transferred to the back side of the sheet.

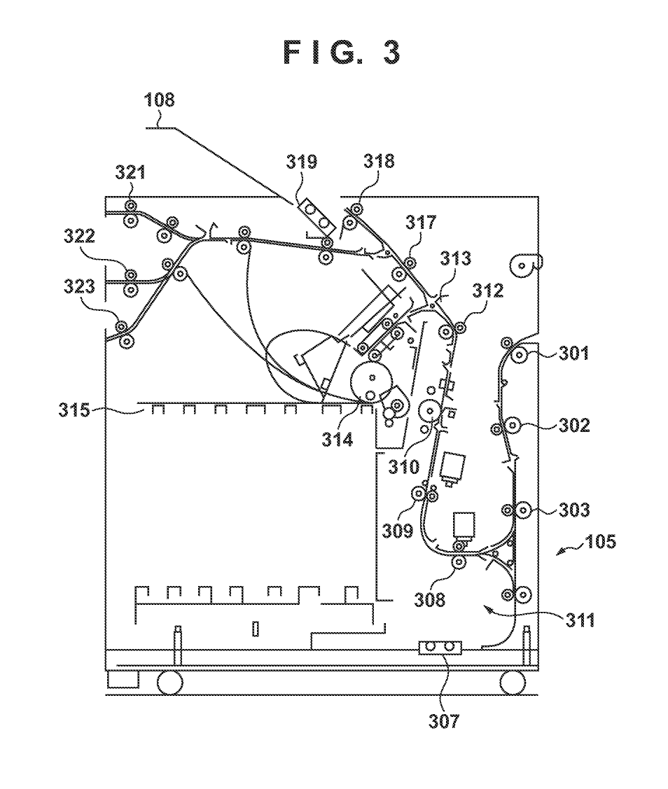

FIG. 3 is a cross-section view of the stacker 105 according to the embodiment.

When it is notified that a printed sheet has been conveyed by the conveyance roller 218 of the printer 102, the sheet is conveyed by driving a conveyance roller group 301, 302, 303, 308, 309, 310 and 312, and a conveyance flapper 313. The conveyance flapper 313 switches whether the conveyed sheet is stacked in a stacking unit 315 or whether the sheet is conveyed to the finisher 106 which is connected to the stacker 105. In a case where the sheet is stacked in the stacking unit 315, the conveyance flapper 313 is controlled and the sheet is conveyed to the stacking unit 315 via a sheet reversing unit 314. On the other hand, in a case where the sheet is conveyed to the finisher 106, the conveyance flapper 313 is controlled and the sheet is conveyed to the finisher 106 by conveyance rollers 317, 321, 322 and 323. The stacker 105 has a sensor 319 for detecting whether or not there is a sheet on the escape tray 108. Note, a conveyance roller 318 is arranged for discharging sheets to the escape tray 108. Also, the stacker 105 has an evacuation unit 311 to which sheets are evacuated, and a sensor 307 for detecting whether or not there is a sheet in the evacuation unit 311. Note, a conveyance roller 318 is provided for discharging sheets to the escape tray 108. The evacuation unit 311 is internal to the stacker 105, and difficult to see, being covered by a cover external to the apparatus. A CPU 401 can receive information from the sensor 319 or the sensor 307.

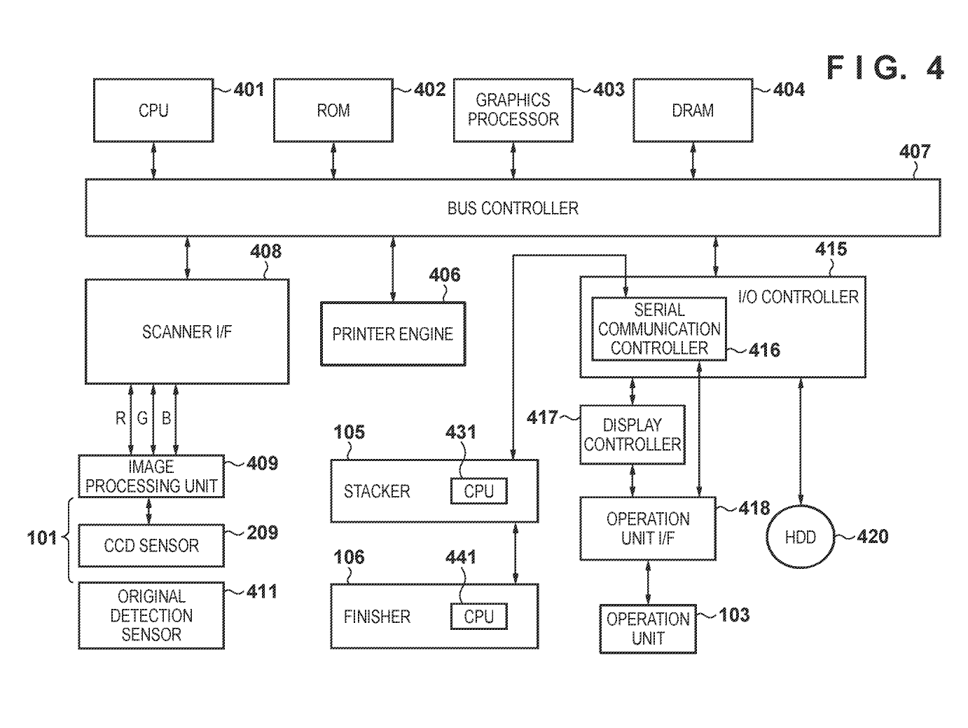

FIG. 4 is a block diagram for showing a configuration of a controller of the printer 102 according to the embodiment.

The CPU 401 controls the printing system, according to control programs stored in the ROM 402 or a boot program in the ROM 402, the control programs having been loaded into a DRAM 404 from a HDD (hard disk drive) 420.

In the scanner 101, image data of an original output from the CCD sensor 209 is converted into an RGB signal by an image processing unit 409, and stored in the DRAM 404 via a scanner I/F 408 and a bus controller 407. The image data is then stored in the HDD 420 via an I/0 controller 415. An original detection sensor 411 detects whether or not an original to be read was set in the scanner 101.

In a case where image data saved in the HDD 420 is printed, the CPU 401, after temporarily saving the image data saved in the HDD 420 to the DRAM 404, and color space conversion processing such as a conversion from RGB to CMYK is performed by a graphics processor 403. Next, the converted image data is output to a printer engine 406 and printed. The printer engine 406 has a configuration as explained with reference to FIG. 2.

Control of the stacker 105 is performed by a CPU 431 which receives information for conveyance from the CPU 401. When the CPU 431 is notified by the CPU 401 that a printed sheet has been conveyed, it conveys the sheet by driving rotation of the conveyance roller groups 301-303, 308-310, and 312. Whether to stack the conveyed sheet in the stacking unit 315 or whether to convey the sheet to the finisher 106, which is connected to the stacker 105, is controlled by the CPU 401 instructing the CPU 431 of the stacker 105 via a serial communication controller 416. In a case where the CPU 431 of the stacker 105, having been instructed by the CPU 401, stacks the conveyed sheet in the stacking unit 315, the CPU 431 controls the conveyance flapper 313 to convey the sheet to the stacking unit 315 via the sheet reversing unit 314. In a case where the sheet is conveyed to the finisher 106, the conveyance flapper 313 is controlled to convey the sheet to the finisher 106 via the conveyance rollers 317, and 321-323.

Note, the CPU 401 determines a conveyance destination and a discharge destination of a printed sheet based on information input by the user from the operation unit 103 that passes through an operation unit I/F 418 and the I/0 controller 415, and in accordance with a control program. Next, the determined discharge destination is sent to the CPU 431 of the stacker 105 in notification via the serial communication controller 416 of the I/0 controller 415.

Display of information from the CPU 401 to the user, and instructions from the user to the CPU 401 are carried out via the operation unit 103. The CPU 401 transmits information to be displayed to the user via the I/0 controller 415 and a display controller 417 to the operation unit I/F 418. Information thus transmitted is provided to the user by display to the display panel 504. Also, when the user inputs information by a key group of the operation unit 103 or by the display panel 504, which is equipped with a resistive or a capacitive touch sensor, input information is transmitted to the CPU 401 via the operation unit I/F 418 and the I/0 controller 415.

Also, communication between the finisher 106 and the printer 102 is performed by communicating with a CPU 441 of the finisher 106 via the serial communication controller 416 of the I/0 controller 415.

FIG. 5 is a top view of the operation unit 103 according to the embodiment.

A numeric keypad 505 is used to set a number of print copies. A start key 509 is a key for instructing starting of a copy, or the like, and a stop key 511 is a key for stopping an in-progress operation. The display panel 504 is equipped with a resistive or capacitive touch sensor, and functions as a touch panel.

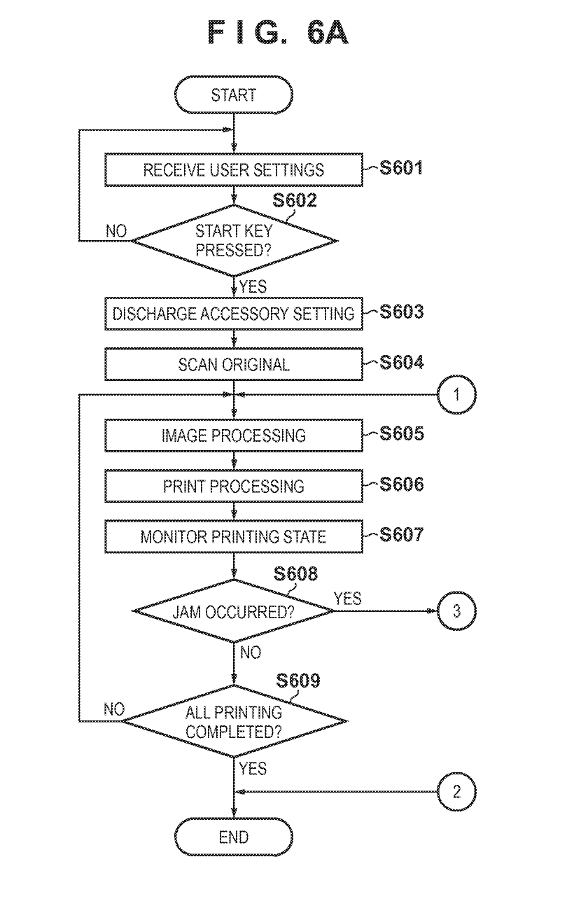

FIGS. 6A and 6B are flowcharts for describing control processing executed by the printer 102 according to the embodiment. This processing may be performed by storing a program for executing this processing in the ROM 402 or in the HDD 420, and having the CPU 401 load, from the ROM 402 or the HDD 420 into the DRAM 404, and execute the program. Note, explanation is given for a case of copy processing by the scanner 101 and the printer 102, but in cases such as execution of a print job received from an external PC, for example, the print processing is executed in basically the same way.

Firstly, in step S601, the CPU 401 receives various settings for a copy performed by the user using the operation unit 103. Next, in step S602, the CPU 401 determines whether or not the start key 509 of the operation unit 103 for instructing initiation of the copy was pressed. When the start key 509 has not been pressed, the processing returns to step S601, and copy settings input by the user are once again received. In step S601, the user inputs such things as which of the feed cassettes 213, 214 and the feed accessory 104 of the printer 102 the sheet to be printed is fed from, how many copies to print, and whether to discharge the printed sheet to the stacker 105, or to discharge to the finisher 106. Information thus input is stored in the DRAM 404 via the operation unit I/F 418 and the I/0 controller 415, under the control of the CPU 401.

In step S602, when the start key 509 is pressed, the processing proceeds to step S603, and the CPU 401 performs setting of the discharge location, and the like, to the CPU 431 of the stacker 105 and the CPU 441 of the finisher 106, in accordance with information saved in the DRAM 404 in step S601. Specifically, the CPU 401 makes a notification of whether or not the discharge destination of the printed sheet is specified to the CPU 431 of the stacker 105 and the CPU 441 of the finisher 106 via the serial communication controller 416 of the I/0 controller 415.

Next, the processing proceeds to step S604 and the CPU 401 makes an instruction for scanning of the original to the scanner 101 via the scanner I/F 408. With this, the scanner 101 scans the original, receives image data obtained by scanning the original via the scanner I/F 408 and stores the image data in the HDD 420. Next, in step S605, the CPU 401 applies image processing by the graphics processor 403 on the image data stored in the HDD 420. Next, the processing proceeds to step S606, and the image data is output to the printer engine 406 and printed.

Next, the processing proceeds to step S607, and the CPU 401 communicates with the CPU 431 of the stacker 105 and the CPU 441 of the finisher 106 via the I/0 controller 415 and the serial communication controller 416 to monitor whether or not the conveyance of the sheets during print processing is performed normally. Here, it is determined whether or not sheets have arrived at a predetermined timing calculated from a length of a conveyance path that sheets fed through the conveyance roller 218 of the printer 102 and the conveyance rollers 301-303, 308, 309, 317, and 321-323 of the stacker 105 pass, and from a conveying speed. In a case where it is determined that a sheet has not arrived at the predetermined timing, it is determined that a paper jam has occurred in the printer 102 or in the stacker 105. Note, when a paper jam has occurred in the stacker 105, notification is made to the CPU 401 via the serial communication controller 416 and the I/0 controller 415 from the CPU 431. In a case where it is determined in step S608 that a paper jam has not occurred, the processing proceeds to step S609, and the CPU 401 determines whether or not printing of the number of copies that the user instructed has completed, and if the printing has not completed, the processing returns to step S605, and the previously described processing is executed.

In a case where, in step S608, the CPU 401 detects that a paper jam occurred, the processing proceeds to step S611. In step S611, the CPU 401 determines whether or not the paper jam was automatically cancelled from information of the paper jam location notified via the serial communication controller 416 by the CPU 431 of the stacker 105 or by the CPU 441 of the finisher 106. In a case where the feed accessory 104, the stacker 105 and the finisher 106 connected to the printer 102 have functions for discharging a sheet stopped in the paper jam automatically to a predetermined location when the paper jam is detected, it is possible to automatically resume the printing without the user dealing with the paper jam. Here, an evacuation area (sheet holding unit) to which a sheet stopped in a paper jam is discharged exists in each unit, and this is the escape tray 107 for the feed accessory 104, escape tray 108 for the stacker 105 and tray 109 and tray 110 for the finisher.

Next, the processing proceeds to step S612, and the CPU 401 determines whether or not the paper jam, that was determined to have occurred in step S608, was automatically cancelled. In a case where it is determined that the paper jam was not automatically cancelled, the processing proceeds to step S613. In step S613, the CPU 401 receives information of the paper jam location sent in notification via the serial communication controller 416 from the CPU 431 of the stacker 105 or the CPU 441 of the finisher 106, and displays to the display panel 504 of the operation unit 103 by transmitting the information to the operation unit I/F 418.

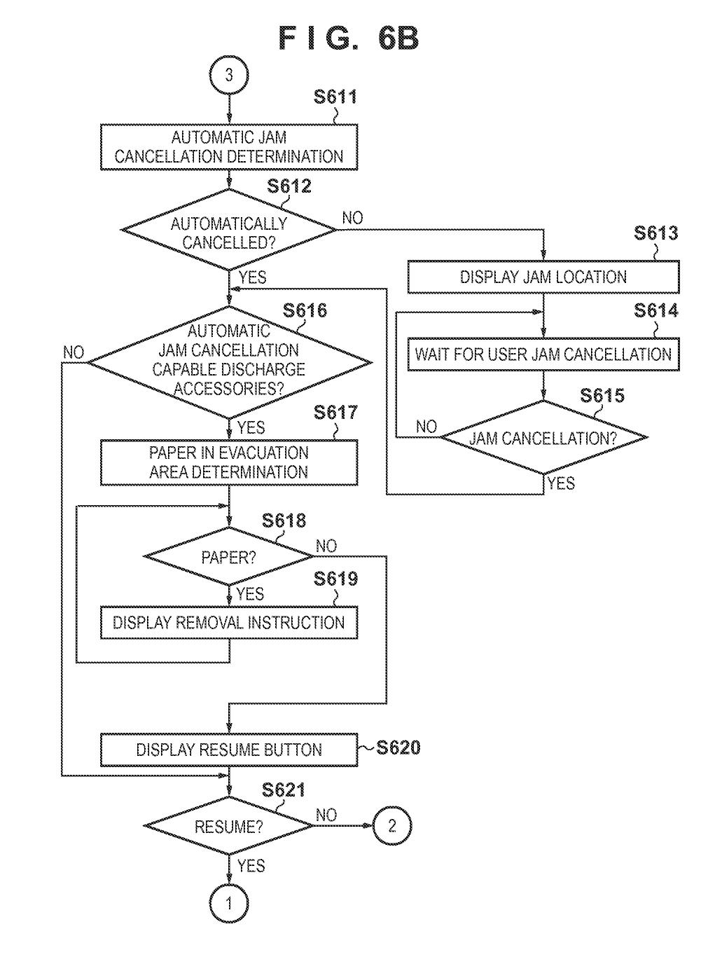

FIG. 7 is a view for showing an example of a screen displayed to the operation unit 103 showing a paper jam location according to the embodiment.

In the example of FIG. 7, it can be seen that the paper jam has occurred in the finisher 106. A message instructing how to deal with this, “open the top cover of the finisher and clear the paper jam” is displayed.

In this way, in step S613, the CPU 401 displays a notification to a user instructing removal of the jammed sheet. Next, in step S614, the CPU 401 performs communication via the serial communication controller 416 with the CPU 441 of the finisher 106 and acquires information of the paper jam location at a fixed frequency. By doing this, the CPU 401 can determine whether or not the paper jam was cancelled by the user. In this way, in step S615, when the CPU 401 detects that the paper jam was cleared, based on paper jam information sent in notification via the serial communication controller 416 from the CPU 441 of the finisher 106, the processing proceeds to step S616.

In step S616, the CPU 401 determines whether or not the connected stacker 105 and finisher 106 are discharge accessories capable of automatic cancellation of the paper jam, having evacuation areas such as escape trays. Here, the CPU 401 queries, via the serial communication controller 416, the CPU 431 of the stacker 105 and the CPU 441 of the finisher 106 as to whether or not automatic cancellation of the paper jam is possible If the stacker 105 and finisher 106 are discharge accessories capable of automatic cancellation of the paper jam, the processing proceeds to step S617, and information as to whether or not there is a sheet stopped in the paper jam in the evacuation area (escape tray, etc.) from the CPU 431 of the stacker 105 or the CPU 441 of the finisher 106. In the present embodiment, the stacker 105 has the escape tray 108 and the evacuation area above the sensor 307 (corresponds to previously described evacuation unit 311) as evacuation areas. Next, with the sensor 307 and the sensor 319, the CPU 431 of the stacker 105 determine whether or not a sheet stopped in the paper jam was automatically evacuated to the escape tray 108 or to the evacuation area above the sensor 307.

Next, in step S618, when the CPU 431 of the stacker 105 determines that a sheet is evacuated to the evacuation area, the CPU 431 notifies the CPU 401 via the serial communication controller 416. The CPU 401, having determined that there is a sheet in the evacuation area, in step S619, displays to the display panel 504 of the operation unit 103, via the operation unit I/F 418, information of the evacuation area in which the sheet was evacuated to based on the information from the CPU 431. Next, instruction to the user to remove the sheet is made, and the processing proceeds to step S618.

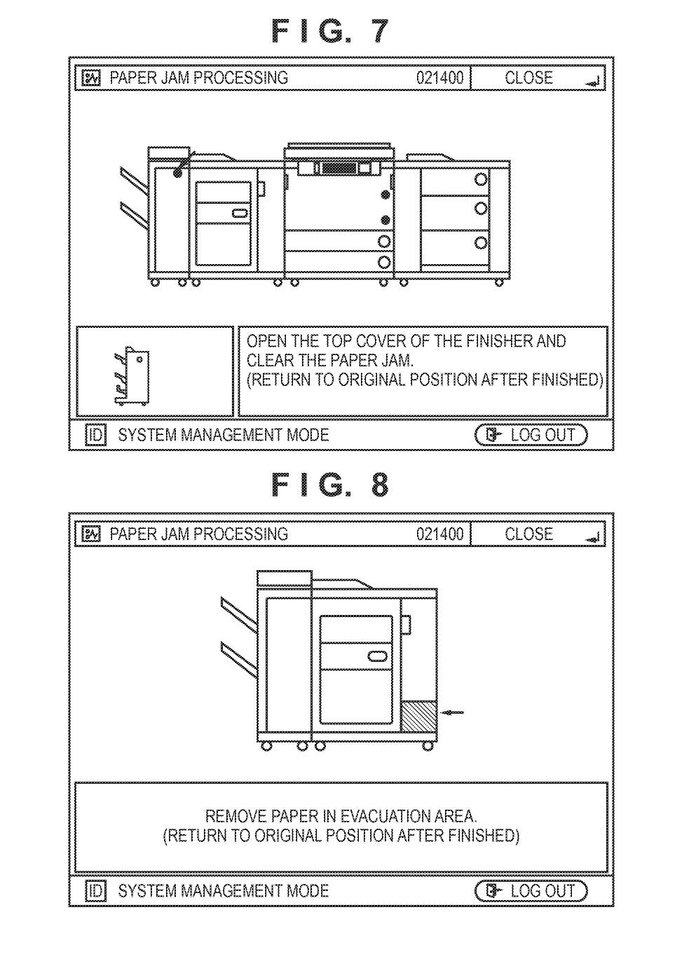

FIG. 8 is a view for showing an example of a screen instructing removal of a sheet from an evacuation area according to the embodiment.

By this it can be seen that a sheet, for which the paper jam occurred, was evacuated to the evacuation area of the stacker 105. A message stating, “please remove the sheet in the evacuation area is displayed, instructing the user to remove the sheet, for which the paper jam occurred, in the evacuation area.

Here, similarly to when the paper jam occurs, the CPU 401 communicates with the CPU 431 of the stacker 105 and the CPU 441 of the finisher 106 and acquires, at a fixed frequency, information of the sheet in the escape tray evacuation area or in another evacuation area. By this, the existence of the sheet in the evacuation area is monitored.

When, in step S618, the CPU 401 determines the sheet in the evacuation area is gone (the sheet has been removed by the user), the processing proceeds to step S618. In step S620, the CPU 401 displays, via the operation unit I/F 418, to the operation unit 103 a screen for allowing the user to select whether or not to continue printing.

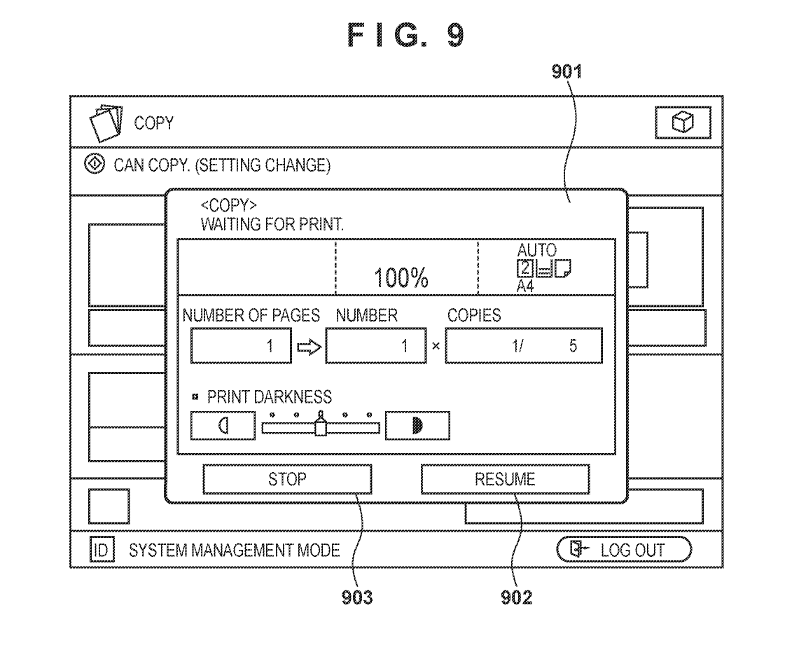

FIG. 9 is a view for showing an example of a copy processing on waiting screen according to the embodiment.

In FIG. 9, copying is interrupted due to a paper jam occurrence, and a dialogue 901 indicating that printing is on waiting is being displayed. On the dialogue 901, a button 902 for querying the user as to whether or not to resume the copying is displayed. When the resume button 902 is pressed, the copy processing is resumed.

In step S620, when a resume instruction is received, the processing proceeds to step S605 from step S621, and the CPU 401 performs image processing of the image data in the DRAM 404 with the graphics processor 403, outputs the processed image data to the printer engine 406, and resumes the printing. Meanwhile, when the stop button 903 in FIG. 9 is pressed, the processing finishes.

By controlling as explained above, not only are sheets evacuated to the evacuation area when a paper jam occurs, which reduces the need for the user to have to deal with paper jams, but also the user is enabled to instruct a continuation of the printing after the fact that a sheet is in the evacuation area is made clear. In particular, even in a case where the evacuation area is internal to the apparatus and difficult for the user to see, the user can easy know that there is a sheet in the evacuation area. This can prevent a highly confidential document, that was evacuated upon occurrence of a paper jam, being seen by another person, for example, while reducing the burden on the user.

Note, while in the above described present embodiment, explanation was given of an example in which the printer, the paper feed unit and the stacker were each separate entities of a system, the present invention is not limited to this and adaptation is possible to a printer apparatus having the printer, the paper feed unit and the stacker all in one body. In such a case, the CPU of the printer apparatus determines such things as the existence of a paper jam, and whether or not a sheet that was evacuated to the evacuation area due to a paper jam is still there.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-264740, filed Dec. 3, 2012, which is hereby incorporated by reference herein in its entirety.

What is claimed is:

1. A printing apparatus comprising:
a determination unit configured to determine whether or not a sheet jam occurs while print processing is performed;
a control unit configured to interrupt the print processing in a case where it is determined by the determination unit that the sheet jam occurs, and to convey a sheet remaining on a sheet conveyance path to a sheet holding unit;
a detection unit configured to detect whether or not there is a sheet in the sheet holding unit; and
a notification unit configured to make a notification to a user instructing removal, from the sheet holding unit, of a sheet in a case where the detection unit detects that there is a sheet in the sheet holding unit.

2. The printing apparatus according to claim 1, further comprising a querying unit configured to make a query to the user as to whether or not to continue print processing interrupted by the sheet jam when the detection unit detects there is no sheet in the sheet holding unit after the notification unit makes the notification.

3. The printing apparatus according to claim 1, wherein the determination unit is further configured to determine that the sheet jam occurs in a case where a sheet does not reach a predetermined location at a predetermined timing calculated from a length of the sheet conveyance path that a fed sheet passes and from a conveying speed.

4. A printing system having a printing apparatus, and a sheet processing apparatus for conveying a sheet on which an image is printed by the printing apparatus, the printing system comprising:
a first determination unit configured to determine whether a sheet jam occurs;
a second determination unit configured to interrupt print processing by the printing apparatus in a case where the first determination unit determines that the sheet jam occurs, and configured to determine whether or not the sheet processing apparatus has a sheet holding unit for holding a sheet remaining on a sheet conveyance path;
a detection unit configured to detect whether or not a sheet is in the sheet holding unit in a case where the second determination unit determined that the sheet processing apparatus has the sheet holding unit; and
a notification unit configured to make a notification to a user instructing removal, from the sheet holding unit, of a sheet in a case where the detection unit detects that there is the sheet in the sheet holding unit.

5. The printing system according to claim 4, further comprising a querying unit configured to make a query to the user as to whether or not to continue print processing interrupted by the sheet jam, when the detection unit detects there is no sheet in the sheet holding unit after the notification unit makes the notification.

6. The printing system according to claim 4, wherein the second determination unit is further configured to determine that the sheet jam occurs in a case where a sheet does not reach a predetermined location at a predetermined timing calculated from a length of the sheet conveyance path that a fed sheet passes and from a conveying speed.

7. A method of controlling a printing apparatus, the method comprising:
determining whether a sheet jam occurs while print processing is performed;
interrupting the print processing in a case where it is determined that the sheet jam occurs, and conveying a sheet remaining on a sheet conveyance path to a sheet holding unit;
detecting whether or not there is a sheet in the sheet holding unit; and
making a notification to a user instructing removal, from the sheet holding unit, of a sheet in a case where it is detected that there is a sheet in the sheet holding unit.

8. A non-transitory computer-readable storage medium storing a program for causing a computer to execute the method according to claim 7.
